(19) United States
(12) Patent Application Publication
(10) Pub. No.: US 2008/0215346 A1
(43) Pub. Date: Sep. 4, 2008

(54) Systems and methods for identity verification

(75) Inventors: Padraig O'Cinneide, Dublin (IE); Andy Scott, Branddan (GB); Aron Barrie, Calgary (CA)

Correspondence Address: Howrey Simon Arnold and White, LLP, 1299 Pennsylvania Ave., NW, Washington, DC, 20004, US

(73) Assignee: NETELLER PLC, Douglas (GB)

(21) Appl. No.: 11/713,107

(22) Filed: Mar. 2, 2007

(51) Int. Cl. G06Q 99/00

(52) U.S. Cl. 705/1

(57) ABSTRACT

The present invention may include systems and a methods for verifying the identity of an individual by invoking the services of at least one databroker. The present invention may establish a predetermined identity verification level and, based on the capabilities of associated databrokers, may establish a number of different solutions for verifying an individual's identity to the predetermined level. When a request for identity verification is received, the present invention may examine the possible solutions for the requested verification level and, by invoking the services of one or more databrokers, may attempt to verify the individual's identity.

### FIELD OF THE INVENTION

The present invention relates to systems and methods for verifying an individual's identity by confirming identifying information associated with a predetermined verification level.

### BACKGROUND OF THE INVENTION

In many types of businesses, it is important for a company to verify the identity of their customers so that activities such as fraud, misrepresentation and money laundering may be prevented. For many businesses, due diligence requires that the identity of a client be verified to at least at least a certain minimum degree before the company may confidently conduct business with the client. For example, to avoid potential lawsuits or other penalties, an online brokerage company may desire to ensure that they are drawing money from, and making investments on behalf of, the correct individual when a client signs up for their services. Additionally, it may be desirable for a company to verify the age of a client when the client signs up for their services.

For other businesses, the federal government requires that the identity of a client be verified to a certain minimum degree. For example, the Bank Secrecy and USA PATRIOT Acts require that banks and other financial institutions identify their clients and ascertain relevant information pertinent to doing financial business with them. This is known as the “Know Your Customer” (‘KYC’) standard and requires, among other things, that businesses verify that their clients are not on any list of known fraudsters, terrorists or money launderers.

In recent years, there has been a dramatic increase in the amount of global business that is transacted electronically, particularly over public networks such as the Internet. These transactions are commonly initiated when a prospective client provides personal information to a business over a network. Because of the “faceless” nature of these transactions, it is relatively easy for a client to provide inaccurate information or misrepresent their identity to the business. Therefore, businesses have been forced to adopt methods of verifying the identity of prospective clients.

The most common means for verifying a prospective client's identity has been to enlist a company which specializes in identity verification. These companies are known as “databrokers” and are typically credit bureaus or credit reference agencies such as Experian, Equifax, TransUnion or Callcredit. However, because businesses must often verify many different types of information, they frequently enlist a databroker which offers broad capabilities, but which also charges high fees for the services. Thus, the costs associated with the verification of a prospective client's identity may be quite high.

Further, databrokers often utilize credit reports or utility information in verifying an individual's identity. Because of this, the verification of individuals who are minimally reported on credit reports or who have never had utilities placed in their name (including younger individuals or recent immigrants, for example) may be quite difficult. As such, a business may be forced to turn down these individuals as prospective clients because of the limitations of the databroker.

Another approach used by some databrokers has been to search multiple databases of identifying information and provide the results of the search to the requesting company. The company is then tasked with comparing the results of the search with the information provided by a prospective client. As such, the requesting company must make the ultimate decision as to whether or not the prospective client's identity can be verified. This may result in a time burden on the requesting company or inaccuracies in the verification because the company may not have sufficient resources necessary to complete the verification.

In light of the problems associated with the methods discussed above, what is needed is a low cost, highly accurate system and method for verifying the identity of any individual.

### SUMMARY OF THE INVENTION

The present invention relates to systems and methods for verifying an individual's identity by confirming identifying information associated with a predetermined verification level.

One embodiment of the present invention may include a method for verifying the identity of an individual by invoking the services of at least one databroker, each databroker having the capability of verifying at least one piece of identifying information associated with an individual. The method may include the step of establishing at least one predetermined level of verification, each predetermined level of verification requiring the verification of at least one piece of identifying information by at least one databroker, wherein a predetermined level of verification may be achieved when each piece of required identifying information is verified. The method may also include the steps of creating a composite set of solutions for achieving each predetermined level of verification, each of the solutions being associated with at least one databroker, receiving a request to verify the identity of an individual at a predetermined level of verification and choosing a solution from the composite set of solutions for the requested predetermined level of verification. Further, the method may include the step of requesting, from the at least one databroker associated with the chosen solution, verification of at least one piece of identifying information associated with the requested predetermined level of verification.

Another embodiment of the present invention may include a processor-based system for verifying the identity of an individual, the system being connected over a network to at least one databroker having the capability of verifying at least one piece of identifying information associated with an individual. The system may include a memory, the memory being stored with at least one predetermined level of verification, each predetermined level of verification requiring the verification of at least one piece of identifying information by at least one databroker, wherein a predetermined level of verification may be achieved when each piece of required identifying information is verified. The memory may also be stored with a composite set of solutions for achieving each predetermined level of verification, each of the solutions being associated with at least one databroker and processor-readable software code configured to enable the processor-based system to execute an identity verification process. The system may also include a processor, the processor being configured to execute the identity verification process, wherein the identity verification process may include the steps of receiving a request to verify the identity of an individual at a predetermined level of verification, choosing a solution from the composite set of solutions for the requested predetermined level of verification and requesting, from the at least one databroker associated with the chosen solution, verification of at least one piece of identifying information associated with the requested predetermined level of verification.

These and other objects and advantages of the invention will be apparent from the following description, the accompanying drawings and the appended claims.

### BRIEF DESCRIPTION OF THE DRAWINGS

While the specification concludes with claims particularly pointing out and distinctly claiming the present invention, it is believed the same will be better understood from the following description taken in conjunction with the accompanying drawings, which illustrate, in a non-limiting fashion, the best mode presently contemplated for carrying out the present invention, and in which like reference numerals designate like parts throughout the Figures, wherein:

FIG. 1A illustrates a system incorporating one embodiment of the present invention.

FIG. 1B illustrates an exemplary block diagram of one embodiment of the identity verification system illustrated in FIG. 1A.

FIGS. 2A and 2B are flowcharts of a method for identity verification according to one embodiment of the present invention.

### DETAILED DESCRIPTION OF THE INVENTION

The present disclosure will now be described more fully with reference to the Figures in which various embodiments of the present invention are shown. The subject matter of this disclosure may, however, be embodied in many different forms and should not be construed as being limited to the embodiments set forth herein.

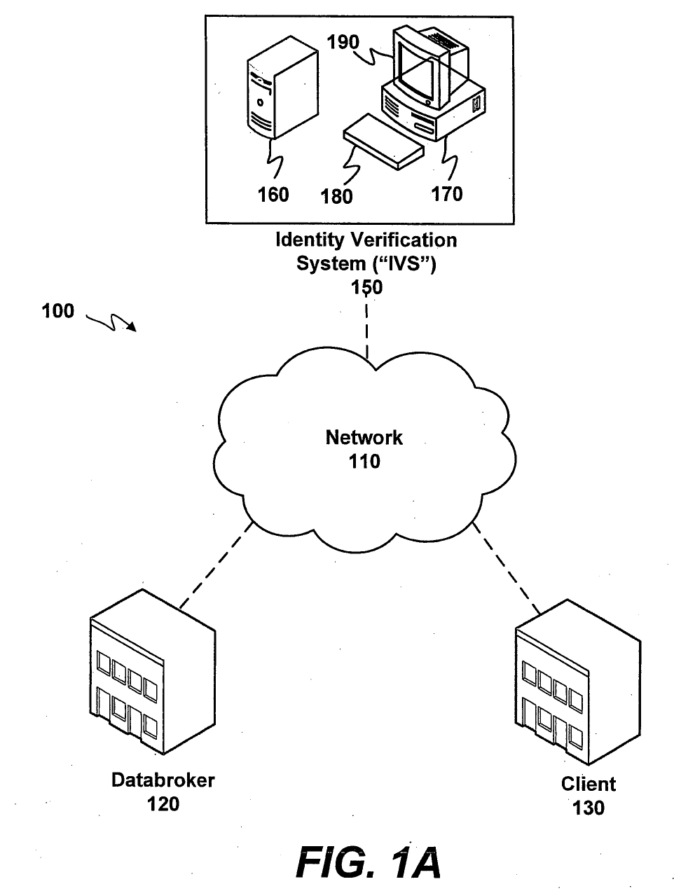

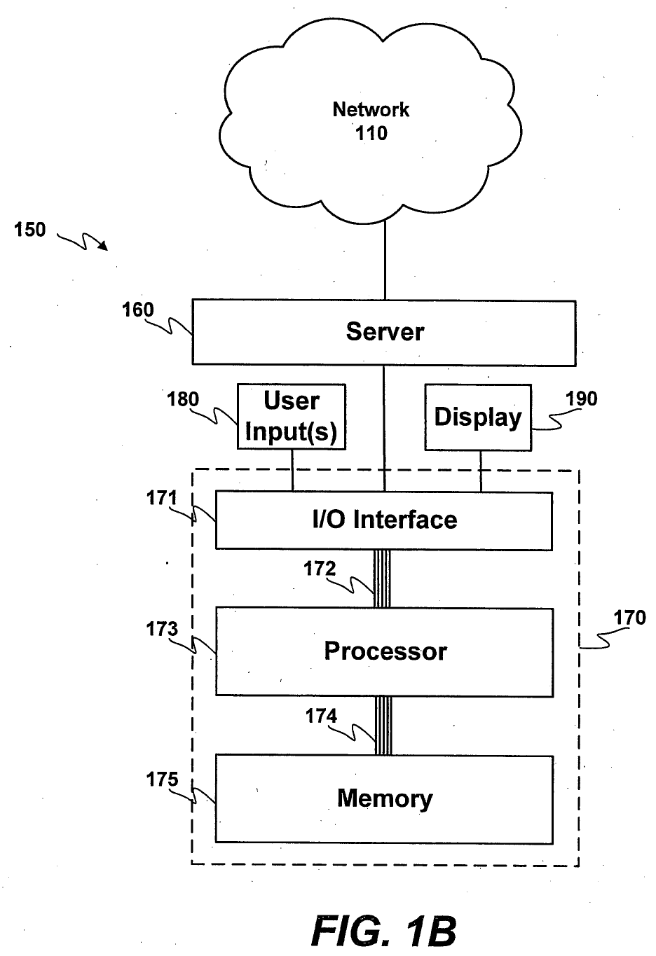

FIG. 1A illustrates a system 100 incorporating one embodiment of the present invention. The system 100 may include an identity verification system (“IVS”) 150, a client 130 and a databroker 120. As further illustrated in FIG. 1A, the IVS 150, the databroker 120 and the client 130 may be coupled via a network 1 10. In one embodiment, any or all of the locations 120, 130 and 150 may include a portion configured as an industry portal including, but not limited to, a vertical portal or vortal accessible over the network 110. While not illustrated in FIG. 1A, it is contemplated that the system 100 may also include additional entities coupled to the network 110. For example, multiple databrokers 120, multiple clients 130 or customers (not shown) of the client 130 may all be configured to access the network 110.

The network 110 may be any means for intercommunication, including a hardwired or wireless network, or a combination thereof, such as the worldwide network broadly defined as the Internet. Furthermore, the present invention may include a network that is accessible by the public or on a private network including, but not limited to, a private internet, a private extranet, a local area network (“LAN”) or a wide area network (“WAN”). In one embodiment, the present invention may include a public network such as the Internet, while utilizing a security model or other interface that limits access to particular information to intended parties only. For example, it is contemplated that login and password information may be required at one or more locations 120, 130 or 150 to access the network 110. In addition, a secure communications protocol, such as secure hypertext transfer protocol (“HTTPS”) may be employed if desired. Furthermore, the terms “network” and “Internet” are intended to encompass not only the hardwired network, but also any means of interfacing therewith including, but not limited to, cellular telephones, personal digital assistants (“PDAs”), satellite and any other telecommunication device known in the art.

The client 130 may be any type of business or individual that desires to verify an individual's identity or information provided by an individual, or to obtain a personal certification of identity. For example, the client 130 may be a banking institution or a website which requires identity or age verification in order to prevent fraudulent representation of identity by individuals accessing the website. Additionally, the client 130 may be any type of regulated business including, but not limited to, an insurance company, an accounting firm or a financial broker. Further, the client 130 may be an individual who desires to obtain a certification of their identity to provide to businesses or other individuals. As discussed earlier, the client 130 may be connected to the network 110 using any means known to those of skill in the art for accessing a network.

In one embodiment, the client 130 may desire to obtain verification of the identity of one or more potential customers. For example, when the client 130 desires to obtain the business of a customer or, alternatively, when the customer desires to purchase goods or services from the client 130, the client 130 may desire to verify the customer's identity or information provided by the customer. For example, in order to conform to government statutes or regulations such as the KYC standard (discussed above), a bank may desire to verify that a potential customer has provided them with accurate information pertaining to their identity.

In other embodiments, the client 130 may wish to obtain verification of information provided by an existing customer before proceeding with a transaction. For example, before a bank may be willing to provide a mortgage loan to an existing customer, the bank may desire to verify the customer's credit rating or other information provided by the customer.

In any case, when a client 130 desires to verify the identity of a customer, the client 130 may submit a request to the IVS 150 via the network 110. The IVS 150 may receive the client's request from the network 110 and may process the request to verify the information provided. During one step of the verification process, the IVS may contact one or more databrokers 120, as discussed in greater detail below. Further, because the client's customer may have access to the network 110, the IVS may contact the client's customer directly to obtain any additional information required for the verification.

The databroker 120 may include any type of database, business or government agency capable of providing verification of information related to an individual. This includes, but is not limited to, credit bureaus, utility companies, state or federal departments of motor vehicles, death databases, electoral rolls, phone records, social security records, financial institutions, police records, or aggregated marketing or surveyed information.

Each databroker 120 may be associated with one or more capabilities, or pieces of information, which it is capable of verifying. Capabilities of various databrokers may include, but are not limited to, one or more of the following pieces of information related to an individual: name, address, telephone number(s), e-mail address, social security number or other national identification number, financial information, date of birth, utility information, driver's license information, passport information, IP address, biometrics, DNA, or a digital certificate. Each databroker 120 will typically be able to at least confirm that a specific piece of information exists. However, each databroker 120 may also be able to validate two or more pieces of information by confirming that the information is linked together.

For example, a telephone company may have the capability to confirm that a specific telephone number provided by a customer of a client 130 exists, but may not have the capability to associate the customer's name with that telephone number (the telephone number may be registered under a different individual's name). Further, a utility company may have the capability to confirm that a specific address provided by a customer-of a client 130 exists, but may not have the capability to associate the name of the customer with that address (the address may be registered under a different individual's name). However, a government agency may have the capability to not only confirm that the name and address provided by a customer of a client 130 exist, but may also have the capability to confirm that the customer's name is associated with the telephone number and the address, therefore linking the customer's name, address and phone number together (thus, the information is deemed to be validated).

Once the IVS 150 has completed the identity verification process, discussed in detail below, the results of the process may be provided to the client 130 over the network 110. In alternative embodiments where the customer of the client 130 is capable of accessing the network 110, the results of the process may also be provided directly to the customer of the client 130.

FIG. 1B illustrates an exemplary block diagram of one embodiment of the IVS 150 illustrated in FIG. 1A. As illustrated in FIG. 1B, one embodiment of the IVS 150 may include a processor-based system 170 connected to a server 160, one or more inputs 180 and a display 190. In one embodiment, the processor-based system 170 may include an input/output (“I/O”) interface 171. In alternative embodiments, various I/O interfaces may be used as I/O interface 171 as long as the functionality of the present invention is retained.

The I/O interface 171 may be coupled to one or more input devices 180 including, but not limited to, user input devices such as a computer mouse, a keyboard, a touch-screen, a track-ball, a microphone (for a processor-based system having speech recognition capabilities), a bar-code or other type of scanner, or any of a number of other input devices capable of permitting input to be entered into the processor-based system 170.

The I/O interface 171 may also be coupled to at least one display 190 for displaying information to a user of the processor-based system 170. Numerous types of displays may be used in connection with the present invention depending on the type information to be displayed. In one embodiment, display 190 may be a monitor, such as an LCD display or a cathode ray tube (“CRT”). Alternatively, the display may be a touch-screen display, an on/off indicator light, an electroluminescent display or any other display that may be configured to display information to a user of processor-based system 170. While a display 190 is illustrated in FIG. 1B, it should be realized that the use of a display is not necessary in every embodiment of the present invention. For example, changes to the IVS 150 may be performed on a development computer and uploaded over a network to the IVS 150.

The I/O interface 171 may be coupled to a processor 173 via a bus 172. The processor 173 may be any type of processor configured to execute one or more application programs, for example. As used herein, the term application program is intended to have its broadest meaning and should include any type of software. Moreover, numerous applications are possible and the present invention is not intended to be limited by the type of application programs being executed or run by processor 173.

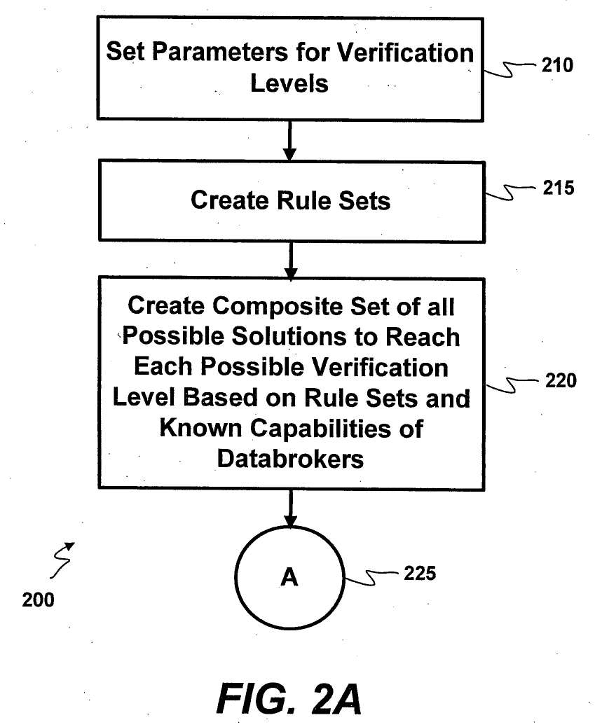

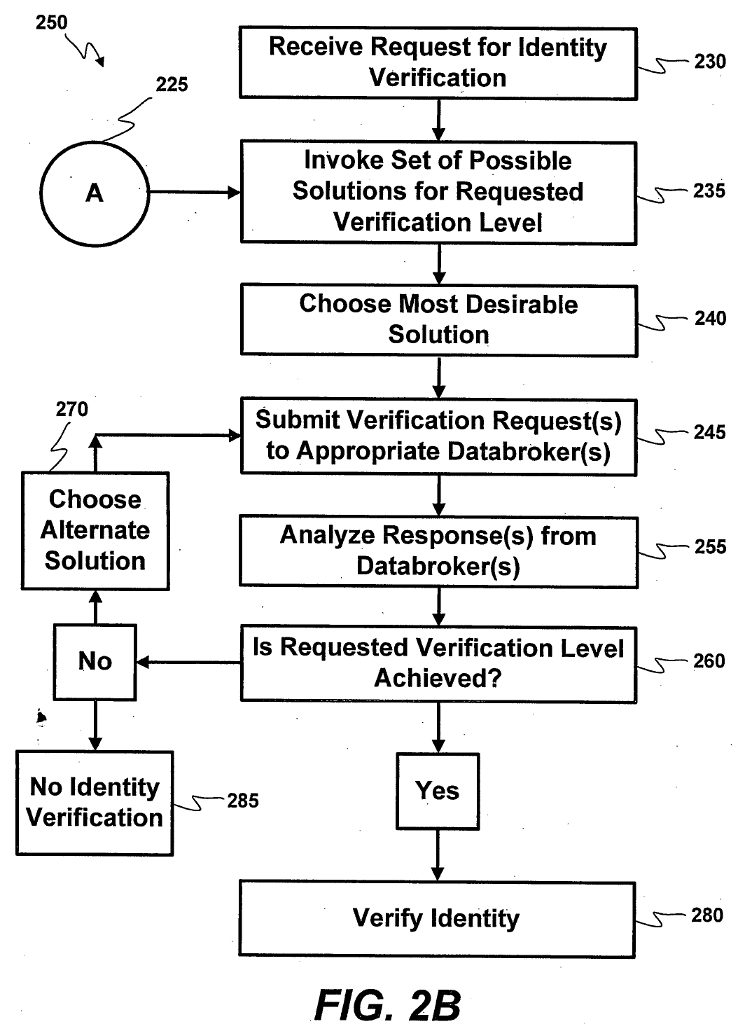

Further, the processor 173 may be coupled to a memory 175 via a bus 174. Memory 175 may be any type of a memory device including, but not limited to, volatile or non-volatile processor-readable media such as any magnetic, solid-state or optical storage media. Processor 173 may be configured to execute software code stored on memory 175 including software code for performing the functions of the processor 173. According to one embodiment of the present invention, memory 175 includes software code, which may be read by the processor, for instructing the processor 173 to execute the identity verification process discussed in detail below with reference to FIGS. 2A and 2B.

The I/O interface 171 may also be coupled to a server 160 for connecting the IVS 150 to the network 110. In one embodiment, the server 160 may take the form of a separate computer, or multiple computers, connected to the processor-based system 170 via a local or public network. In alternative embodiments, the server may be an integral part of processor-based system 170, with both the processor-based system 170 and the server 160 existing, for example, in a single personal computer.

Server 160 may be configured to receive information from a client 130, a customer of the client 130 or one or more databrokers 120. This information may include, but is not limited to, a request for identity verification, information related to a request for identity verification or payment information. In one embodiment, information received by server 160 will be passed along to the processor-based system 170.

Further, server 160 may be configured to send information to a client 130, a customer of the client 130 or one or more databrokers 120. This information may include, but is not limited to, the results of an identity verification request, information related to a request for identity verification or payment information.

Where the systems of a client 130, a customer of the client 130 or a databroker 120 are sufficiently technologically sophisticated, a standard communication format may be utilized. In one embodiment, for example, the generalized markup language (SGML), specifically the extensible markup language (XML), may be used. In other embodiments, however, the IVS 150 may be accessible over any commercially available interface including, but not limited to, http, JMS, e-mail, SMS or FTP protocols. Further, because IVS 150 may interact with many different types of systems for accessing the network 110, the present invention may be provided with the capability of converting data that is sent or received into a common format which may be read by the processor-based system 170.

FIGS. 2A and 2B are flowcharts of a method 200 and 250 for identity verification according to one embodiment of the present invention. Before a request for identity verification may be received or processed, at least one verification level must be established and stored in memory 175 for later access by processor 173. Each predetermined verification level may require the confirmation or validation of any number of identifying pieces of information. Typically, a lower verification level will require the confirmation or validation of a lesser number of pieces of identifying information than a higher level of verification. For example, one verification level may require the confirmation or validation of a sufficient amount of identifying information to satisfy the government's KYC standard. This may include, but is not limited to, confirmation of the individual's name, social security number, address and phone number and validation of the individual's name with the social security number, the address and the phone number. A higher verification level, however, may also require the confirmation or validation of additional identifying information such as a driver's license number or financial information.

Each level of verification may be pre-set by a user of the IVS 150 using any conventional means for interacting with a processor based system including, but not limited to, the use of one or more user inputs 180 and display 190 or may be uploaded from an external system. As discussed in greater detail below with regard to FIG. 2B, when a client 130 submits a request for identity verification to the IVS 150, the client may specify a desired verification level at which the identity verification should be performed.

As shown at step 210, a number of parameters for each verification level may be set. The parameters may include the identifying information which must be confirmed or validated in order to achieve each verification level. As mentioned above, the amount of information which must be confirmed or validated may differ between verification levels. Furthermore, there may be alternate ways to achieve each verification level by obtaining confirmation or validation of different pieces of identifying information.

To continue with the example discussed above, if it is not possible to confirm and validate an individual's address and phone number, the verification may be achieved by alternatively confirming and validating the individual's voter registration. In summary, each verification level may be achievable by the confirmation or validation of different combinations of identifying information.

The parameters for each verification level may also include the region or subregion in which the verification level is to apply. For example, a user may establish one level for verification of the identity of citizens or residents of the United States and a separate level for citizens or residents of Canada. Further, the user may establish different levels for subregions within each region. For example, this may include a separate level for each state within the United States or each province or territory in Canada.

At step 215, rule sets may be created for achieving each verification level. These rule sets may include one or more rules for achieving each verification level. In one embodiment, the rules may specify the manner in which different types of identifying information are to be confirmed or validated in a specific region or subregion for which the identity verification level is to be applied. For example, a rule may be created which specifies that the New York State driver's license database is to be accessed when the verification level requires confirmation or validation of the driver's license number of a resident of the state of New York.

Furthermore, the rules may specify the manner in which different types of identifying information are to be confirmed or validated based on the specific capabilities of one or more databrokers. Many different types of databrokers only offer the capability to confirm or validate specific types of information. For example, a rule may be created which specifies that whenever an individual's credit rating is to be confirmed or validated, a credit bureau should be contacted.

In one embodiment of the present invention, rule sets may be established by a user of the IVS 150 and stored in memory 175. In this embodiment, the IVS 150 may include a rules engine stored in memory 175 and accessed by processor 173 or the rules engine may be provided on a separate processor or memory device. The rules engine may interface with user inputs 180 or display 190. This may allow a user to interact with the rules engine and create rule sets for each verification level.

As illustrated at step 220, once the parameters and rule sets are established for a verification level, a composite set of all possible solutions for obtaining the verification level may be created by processor 173. The composite set of solutions, as discussed below, may include all capabilities of all databrokers associated with the IVS 150. For simplicity, the following detailed description will refer to only one verification level. However, it will be readily apparent to one of skill in the art that the following description will apply to each verification level that is established in step 210.

It should be noted that, when a databroker 120 is established as a databroker which may be utilized by the IVS 150, the different capabilities of the databroker 120 may be stored in memory 175. In one embodiment, the establishment of a databroker as a compatible databroker 120 may be performed manually by a user with inputs 180 or display 190 or may be uploaded from an external system. In alternative embodiments, the IVS 150 may provide the ability for a databroker to automatically establish itself with the IVS 150. In any case, when a databroker is established with the IVS 150, its capabilities (the type or types of information that it is capable of confirming or validating) may also be stored in memory 175 and may be utilized in the creation of the composite set of solutions at step 220.

Additionally, a user of the IVS 150 or the IVS 150 may assign a measure of quality to the various capabilities of each databroker 120 and store the measure(s) of quality in memory 175. The measure of quality for each capability may be based on the user's or the IVS' confidence in the databroker's ability to produce an accurate confirmation or validation of one or more pieces of identifying information. Further, the measure of quality may be changed or updated, for example, based on a measure of the databroker's coverage, accuracy or trustworthiness. For each solution in the composite set of solutions, an overall measure of quality may then be assigned based on the measure of quality assigned to each specific capability.

Further, a user of the IVS 150 or the IVS 150 may assign a measure of cost to each databroker 120 and store the measure of cost in memory 175. The measure of cost may represent the cost for confirming or validating one or more pieces of identifying information with that databroker. The measure of cost may also represent a cost established between the databroker and a user of the IVS 150 or the IVS 150 (by contract or other agreement). In some embodiments, databrokers may provide information regarding all of their capabilities upon each request. As such, the measure of cost associated with each databroker may be fixed. However, in other embodiments, databrokers may charge per piece of information sought to be confirmed or validated. Thus, the measure of cost associated with each databroker may be based on the number of pieces of information which are to be confirmed or validated.

Finally, a user of the IVS 150 or the IVS 150 may assign a measure of time to each databroker 120 and store the measure of time in memory 175. The measure of time may represent the length of time that will occur between the time when a request for confirmation or validation of identifying information is sent to a databroker and the time when the databroker responds to the request. In some embodiments, databrokers may provide information regarding all of their capabilities upon each request. As such, the measure of time associated with each databroker may be fixed. However, in other embodiments, databrokers may take more or less time depending on the amount of information sought to be confirmed or validated. Thus, the measure of time associated with each databroker may be based on the number of pieces of information which are to be confirmed or validated.

Once the capabilities and their associated measure of quality, cost time are entered into memory 175 for each databroker 120, the IVS 150 may create a composite set of all possible solutions for achieving a verification level and may store the composite set of solutions in memory 175. This composite set of solutions may represent the various combinations of databrokers which may be contacted in order to confirm or validate the pieces of information required by the verification level. Often, one databroker 120 may have the capabilities to confirm or validate all required pieces of information for the verification level. Alternatively, multiple databrokers may be required to confirm or validate all required pieces of information for the verification level.

As an example, suppose that IVS 150 is associated with only databrokers A and B, and that the capabilities and associated measures of quality, time and cost for each of these databrokers have been stored in memory 175. Databroker A has the capabilities to confirm name, address, phone number and social security number (“SSN”) and can validate name with address and name with SSN. Databroker B has the capabilities to confirm address and SSN and validate address with SSN. Further, suppose that databroker A costs $0.35 and databroker B costs $0.25 per request for information (these are fixed costs which are the same regardless of the amount of information sought to be confirmed or validated). Finally, suppose that databroker A takes 2.0 seconds and databroker B takes 1.5 seconds to respond to a request for information (this is a fixed time which is the same regardless of the amount of information sought to be confirmed or validated).

If verification level X requires confirmation of name, address and SSN and validation of name with address and name with SSN, the IVS 150 may create a composite set of the possible solutions for achieving verification level X based on the known capabilities and measures of quality, time and cost of the databrokers associated with the IVS 150. It should be realized that, while verification level X requires validation of name with address and name with SSN, a validation of name with address and address with SSN will also meet the requirements for validation. Therefore, any possible “links” between validation requirements may be included in the composite set of solutions. The composite set of solutions may be represented as follows:

| Possible | | | | | Solution | Total | Total Cost |
|---|---|---|---|---|---|---|---|
| Solution | Capability | Criteria Satisfied | Databroker | Quality | Quality | Time (s) | ($) |
| 1 | Name | Confirm Name | A | 0.90 | 0.4097 | 2.0 | 0.35 |
| | SSN | Confirm SSN | A | 0.85 | | | |
| | Address | Confirm Address | A | 0.70 | | | |
| | Name - SSN | Validate Name with | A | 0.85 | | | |
| | | SSN | | | | | |
| | Name - Address | Validate Name with | A | 0.90 | | | |
| | | Address | | | | | |
| 2 | Name | Confirm Name | A | 0.90 | 0.4389 | 2.0 | 0.60 |
| | SSN | Confirm SSN | A | 0.85 | | | |
| | Address | Confirm Address | B | 0.75 | | | |
| | Name - SSN | Validate Name with | A | 0.85 | | | |
| | | SSN | | | | | |
| | Name - Address | Validate Name with | A | 0.90 | | | |
| | | Address | | | | | |
| 3 | Name | Confirm Name | A | 0.90 | 0.3856 | 2.0 | 0.60 |
| | SSN | Confirm SSN | B | 0.80 | | | |
| | Address | Confirm Address | A | 0.70 | | | |
| | Name - SSN | Validate Name with | A | 0.85 | | | |
| | | SSN | | | | | |
| | Name - Address | Validate Name with | A | 0.90 | | | |
| | | Address | | | | | |
| 4 | Name | Confirm Name | A | 0.90 | 0.4131 | 2.0 | 0.60 |
| | SSN | Confirm SSN | B | 0.80 | | | |
| | Address | Confirm Address | B | 0.75 | | | |
| | Name - SSN | Validate Name with | A | 0.85 | | | |
| | | SSN | | | | | |
| | Name - Address | Validate Name with | A | 0.90 | | | |
| | | Address | | | | | |
| 5 | Name | Confirm Name | A | 0.90 | 0.3641 | 2.0 | 0.60 |
| | SSN | Confirm SSN | A | 0.85 | | | |
| | Address | Confirm Address | A | 0.70 | | | |
| | Name - SSN | Validate Name with | A | 0.85 | | | |
| | | SSN | | | | | |
| | SSN - Address | Validate SSN with | B | 0.80 | | | |
| | | Address | | | | | |
| 6 | Name | Confirm Name | A | 0.90 | 0.3902 | 2.0 | 0.60 |
| | SSN | Confirm SSN | A | 0.85 | | | |
| | Address | Confirm Address | B | 0.75 | | | |
| | Name - SSN | Validate Name with | A | 0.85 | | | |
| | | SSN | | | | | |
| | SSN - Address | Validate SSN with | B | 0.80 | | | |
| | | Address | | | | | |
| 7 | Name | Confirm Name | A | 0.90 | 0.3427 | 2.0 | 0.60 |
| | SSN | Confirm SSN | B | 0.80 | | | |
| | Address | Confirm Address | A | 0.70 | | | |
| | Name - SSN | Validate Name with | A | 0.85 | | | |
| | | SSN | | | | | |
| | SSN - Address | Validate SSN with | B | 0.80 | | | |
| | | Address | | | | | |
| 8 | Name | Confirm Name | A | 0.90 | 0.3672 | 2.0 | 0.60 |
| | SSN | Confirm SSN | B | 0.80 | | | |
| | Address | Confirm Address | B | 0.75 | | | |
| | Name - SSN | Validate Name with | A | 0.85 | | | |
| | | SSN | | | | | |
| | SSN - Address | Validate SSN with | B | 0.80 | | | |
| | | Address | | | | | |
| 9 | Name | Confirm Name | A | 0.90 | 0.3856 | 2.0 | 0.60 |
| | SSN | Confirm SSN | A | 0.85 | | | |
| | Address | Confirm Address | A | 0.70 | | | |
| | Name - SSN | Validate Name with | A | 0.90 | | | |
| | | SSN | | | | | |
| | SSN - Address | Validate SSN with | B | 0.80 | | | |
| | | Address | | | | | |
| 10 | Name | Confirm Name | A | 0.90 | 0.4131 | 2.0 | 0.60 |
| | SSN | Confirm SSN | A | 0.85 | | | |
| | Address | Confirm Address | B | 0.75 | | | |
| | Name - Address | Validate Name with | A | 0.90 | | | |
| | | Address | | | | | |
| | SSN - Address | Validate SSN with | B | 0.80 | | | |
| | | Address | | | | | |
| 11 | Name | Confirm Name | A | 0.90 | 0.3629 | 2.0 | 0.60 |
| | SSN | Confirm SSN | B | 0.80 | | | |
| | Address | Confirm Address | A | 0.70 | | | |
| | Name - Address | Validate Name with | A | 0.90 | | | |
| | | Address | | | | | |
| | SSN - Address | Validate SSN with | B | 0.80 | | | |
| | | Address | | | | | |
| 12 | Name | Confirm Name | A | 0.90 | 0.3888 | 2.0 | 0.60 |
| | SSN | Confirm SSN | B | 0.80 | | | |
| | Address | Confirm Address | B | 0.75 | | | |
| | Name - Address | Validate Name with | A | 0.90 | | | |
| | | Address | | | | | |
| | SSN - Address | Validate SSN with | B | 0.80 | | | |
| | | Address | | | | | |

As discussed earlier, the confirmation or validation of pieces of information may be achieved by combining various capabilities of various databrokers. Furthermore, each solution in the composite set of solution may have one or more of an associated overall quality, a total time and a total cost. When a composite set of all possible solutions for a verification level, based on the capabilities of all databrokers associated with the IVS 150, such as the composite set listed above, has been created, it may then be stored in memory 175. The storage of the composite set of solutions is illustrated in FIG. 2A at step 225. As one of skill in the art will realize, as the number of capabilities of a databroker changes, the number of associated databrokers changes, or the quality, time or cost of each capability for each databroker changes, the composite set of solutions may be altered or updated by either a user of the IVS 150 or the IVS 150 itself.

When the IVS 150 receives a request for the verification of an identity of an individual, the system may initiate method 250 illustrated in FIG. 2B. As discussed above with respect to FIG. 1A, a request for identity verification will typically be received from a client 130. The request will typically include an indication of the level of verification at which the identity is to be verified. Further, the request may include information about the individual that has been provided to the client 130. In one embodiment, this information may be provided by a customer of the client 130 and the client 130 may desire to verify the information that the customer provides. Furthermore, the client 130 may specify as to whether the identity verification should be performed at a minimal cost or in a minimal amount of time.

As illustrated at step 235, once a request for identity verification has been received, the IVS 150 may invoke the composite set of solutions 225 for the requested verification level. As discussed with respect to FIG. 2A, the composite set of solutions 225 may have been previously stored in memory 175.

Next, at step 240, the IVS 150 may examine the composite set of solutions and choose the most desirable solution. The most desirable solution may be, for example, the solution having the highest measure of quality, the lowest measure of time or the lowest measure of cost. In one embodiment, the client 130 may indicate whether solutions should be chosen based on quality, cost or time.

As illustrated at step 245, once the most desirable solution from the composite set of solutions has been chosen, the IVS 150 may submit verification requests to the databroker or databrokers 120 associated with the chosen solution. To reiterate, the verification requests may include requests for confirmation or validation of identifying information associated with the individual whose identity is sought to be verified.

The databrokers 120 may then provide IVS 150 a response to the verification request or requests. The response will typically include a confirmation, a non-confirmation, a validation or a non-validation of the information sought to be verified. As illustrated at steps 255 and 260, once the response is received, the IVS 150 may then analyze the response to determine whether the requested level of verification has been achieved.

If the requested verification level has been achieved, i.e. all information requested is confirmed or validated, the IVS 150 may proceed to step 280 and verify the identity of the individual at the requested level of verification. In one embodiment, verification of the identity of the individual at the requested level of verification may then be provided to the requesting client 130. However, in alternative embodiments, the verification may be provided directly to a customer of the client 130 or the individual subject to the identity verification request.

On the other hand, if the initial request for information does not yield a verification of the identity, the IVS 150 may then reexamine the composite set of solutions created and stored in memory. The IVS 150 may then fill in any information confirmed or validated by the databroker or databrokers initially contacted and determine whether any additional solutions remain in the composite set of solutions. Generally, there will be an additional solution if there remains databrokers with the capability to confirm or validate the missing information that have not been contacted. If no additional solutions remain, the IVS 150 may determine that no identity verification is possible at step 285.

However, if additional solutions remain, the IVS 150 may choose an alternate solution at step 270 from the composite set of solutions. As illustrated in FIG. 2B, the IVS 150 may then submit a verification request or requests to any remaining databrokers. This iteration may continue until the requested identity may be verified or until there are no remaining solutions in the composite set of solutions.

To continue with the example discussed earlier with respect to FIG. 2A, we will assume that the IVS 150 receives a request from a client 130 for the verification of an individual's identity at verification level X. Further, we will assume that the client 130 has provided a name, address, telephone number and SSN provided to the client by the individual. Finally, we will assume that the client 130 has designated that it desires to incur minimal cost in verifying the identity of the individual.

Initially, the IVS 150 will invoke the composite set of solutions for verification level X created earlier. Because the client 130 has asked that the most desirable solution be chosen based on cost, solution 1 will be selected Solution 1 requires that only databroker A be contacted to confirm the name, SSN and address and to validate the name with the SSN and the name with address. As such, databroker A will be contacted via the network.

For purposes of the present example, we will assume that databroker A was able to confirm the name and the address and to validate the name with the address but was unable to confirm SSN and unable to validate the name with the SSN. As such, solution 1 is unable to verify the identity of the individual.

However, because the name and address have been confirmed and the name has been confirmed with the address, the composite set of solutions may be altered to indicate a capability quality of 1.00 for the confirmation of the address and the name and the validation of the address with the name from databroker A. Similarly, the composite set of solutions may be altered to indicate a capability of 0.00 for the confirmation of the SSN and the validation of the name with the SSN for databroker A. The qualities assigned to the capabilities of databroker B will remain unaltered because databroker B has not yet been contacted. The altered composite set of solutions may then appear as follows:

| Possible | | | | | Solution | Total | Total Cost |
|---|---|---|---|---|---|---|---|
| Solution | Capability | Criteria Satisfied | Databroker | Quality | Quality | Time (s) | ($) |
| 1 | Name | Confirm Name | A | 1.00 | 0.00 | | |
| | SSN | Confirm SSN | A | 0.00 | | | |
| | Address | Confirm Address | A | 1.00 | | | |
| | Name - SSN | Validate Name with | A | 0.00 | | | |
| | | SSN | | | | | |
| | Name - Address | Validate Name with | A | 1.00 | | | |
| | | Address | | | | | |
| 2 | Name | Confirm Name | A | 1.00 | 0.00 | | |
| | SSN | Confirm SSN | A | 0.00 | | | |
| | Address | Confirm Address | B | 0.75 | | | |
| | Name - SSN | Validate Name with | A | 0.00 | | | |
| | | SSN | | | | | |
| | Name - Address | Validate Name with | A | 1.00 | | | |
| | | Address | | | | | |
| 3 | Name | Confirm Name | A | 1.00 | 0.00 | | |
| | SSN | Confirm SSN | B | 0.80 | | | |
| | Address | Confirm Address | A | 1.00 | | | |
| | Name - SSN | Validate Name with | A | 0.00 | | | |
| | | SSN | | | | | |
| | Name - Address | Validate Name with | A | 1.00 | | | |
| | | Address | | | | | |
| 4 | Name | Confirm Name | A | 1.00 | 0.00 | | |
| | SSN | Confirm SSN | B | 0.80 | | | |
| | Address | Confirm Address | B | 0.75 | | | |
| | Name - SSN | Validate Name with | A | 0.00 | | | |
| | | SSN | | | | | |
| | Name - Address | Validate Name with | A | 1.00 | | | |
| | | Address | | | | | |
| 5 | Name | Confirm Name | A | 1.00 | 0.00 | | |
| | SSN | Confirm SSN | A | 0.00 | | | |
| | Address | Confirm Address | A | 1.00 | | | |
| | Name - SSN | Validate Name with | A | 0.00 | | | |
| | | SSN | | | | | |
| | SSN - Address | Validate SSN with | B | 0.80 | | | |
| | | Address | | | | | |
| 6 | Name | Confirm Name | A | 1.00 | 0.00 | | |
| | SSN | Confirm SSN | A | 0.00 | | | |
| | Address | Confirm Address | B | 0.75 | | | |
| | Name - SSN | Validate Name with | A | 0.00 | | | |
| | | SSN | | | | | |
| | SSN - Address | Validate SSN with | B | 0.80 | | | |
| | | Address | | | | | |
| 7 | Name | Confirm Name | A | 1.00 | 0.00 | | |
| | SSN | Confirm SSN | B | 0.80 | | | |
| | Address | Confirm Address | A | 1.00 | | | |
| | Name - SSN | Validate Name with | A | 0.00 | | | |
| | | SSN | | | | | |
| | SSN - Address | Validate SSN with | B | 0.80 | | | |
| | | Address | | | | | |
| 8 | Name | Confirm Name | A | 1.00 | 0.00 | | |
| | SSN | Confirm SSN | B | 0.80 | | | |
| | Address | Confirm Address | B | 0.75 | | | |
| | Name - SSN | Validate Name with | A | 0.00 | | | |
| | | SSN | | | | | |
| | SSN - Address | Validate SSN with | B | 0.80 | | | |
| | | Address | | | | | |
| 9 | Name | Confirm Name | A | 1.00 | 0.00 | | |
| | SSN | Confirm SSN | A | 0.00 | | | |
| | Address | Confirm Address | A | 1.00 | | | |
| | Name - SSN | Validate Name with | A | 0.00 | | | |
| | | SSN | | | | | |
| | SSN - Address | Validate SSN with | B | 0.80 | | | |
| | | Address | | | | | |
| 10 | Name | Confirm Name | A | 1.00 | 0.00 | | |
| | SSN | Confirm SSN | A | 0.00 | | | |
| | Address | Confirm Address | B | 0.75 | | | |
| | Name - Address | Validate Name with | A | 1.00 | | | |
| | | Address | | | | | |
| | SSN - Address | Validate SSN with | B | 0.80 | | | |
| | | Address | | | | | |
| 11 | Name | Confirm Name | A | 1.00 | 0.6400 | 1.5 | 0.25 |
| | SSN | Confirm SSN | B | 0.80 | | | |
| | Address | Confirm Address | A | 1.00 | | | |
| | Name - Address | Validate Name with | A | 1.00 | | | |
| | | Address | | | | | |
| | SSN - Address | Validate SSN with | B | 0.80 | | | |
| | | Address | | | | | |
| 12 | Name | Confirm Name | A | 1.00 | 0.4800 | 1.5 | 0.25 |
| | SSN | Confirm SSN | B | 0.80 | | | |
| | Address | Confirm Address | B | 0.75 | | | |
| | Name - Address | Validate Name with | A | 1.00 | | | |
| | | Address | | | | | |
| | SSN - Address | Validate SSN with | B | 0.80 | | | |
| | | Address | | | | | |

As is apparent by the altered composite of solutions, once databroker A's results are received, only two viable solutions (solutions 11 and 12) remain because the other solutions require either confirmation or validation of a piece of information from databroker A that databroker A is unable to provide. Thus, the solution quality for solutions 1-10 is now 0.00. Further, the composite set of solutions may be altered to reflect the solution quality of the remaining solution after the results are received from the databroker initially contacted. Finally, the cost and time may be altered to reflect the additional cost and time for pursuing the remaining solutions.

Based on the remaining solutions (solutions 11 and 12), the IVS may select solution 11 because the quality of the solution is higher than that of solution 12. As such, the IVS 150 may contact databroker B to attempt to confirm the SSN and validate the SSN with the address. If databroker B is unable to confirm the SSN and validate the SSN with the address, there will be no remaining solutions and the individual's identity will not be able to be verified at verification level X. However, if databroker B is able to confirm at least the SSN and validate the SSN with the address, solution 11 will be achieved and the IVS 150 will be able to verify the identity of the individual at verification level X. It should be noted that if databroker B is also able to confirm address, both solution 11 and solution 12 will be achieved.

As illustrated by the above example, and as will be readily apparent to one of skill in the art, the present invention offers many advantages over previous attempts at obtaining verification of an individual's identity. Because, in one embodiment, solutions may be chosen based on quality, time or cost, clients may be provided with the ability to tailor searches based on their own preferences. Additionally, because the present invention has the ability to invoke the services of multiple databrokers, identity verification may be more accurate and more robust than previous systems for verifying identity.

Furthermore, because the present invention may utilize “nonconventional” databrokers such as government and utility databases, it may be easier to verify the identity of individuals with little or no credit history (including, but not limited to, recent immigrants or younger individuals who have not engaged in a sufficient amount of business to establish a credit rating). This may enable clients to engage in business with a greater number of individuals.

The foregoing descriptions of specific embodiments of the present invention are presented for purposes of illustration and description. They are not intended to be exhaustive or to limit the invention to the precise forms disclosed. Obviously, many modifications and variations are possible in view of the above teachings. While the embodiments were chosen and described in order to best explain the principles of the invention and its practical applications, thereby enabling others skilled in the art to best utilize the invention, various embodiments with various modifications as are suited to the particular use are also possible. The scope of the invention is to be defined only by the claims appended hereto, and by their equivalents.

What is claimed is:

1. A method for verifying the identity of an individual by invoking the services of at least one databroker, each databroker having the capability of verifying at least one piece of identifying information associated with an individual, the method comprising the steps of:
establishing at least one predetermined level of verification, each predetermined level of verification requiring the verification of at least one piece of identifying information by at least one databroker, wherein a predetermined level of verification is achieved when each piece of required identifying information is verified;
creating a composite set of solutions for achieving each predetermined level of verification, each of the solutions being associated with at least one databroker;
receiving a request to verify the identity of an individual at a predetermined level of verification;
choosing a solution from the composite set of solutions for the requested predetermined level of verification; and
requesting, from the at least one databroker associated with the chosen solution, verification of at least one piece of identifying information associated with the requested predetermined level of verification.

2. The method according to claim 1, further comprising the step of receiving, from the at least one databroker associated with the chosen solution, a response to the request for verification of the at least one piece of identifying information.

3. The method according to claim 2, wherein the response to the request for verification is either a verification of the at least one piece of identifying information or a non-verification of the at least one piece of identifying information.

4. The method according to claim 2, wherein the response to a request for verification is converted into a common data format.

5. The method according to claim 1, wherein the request to verify the identity of an individual is a request from a client to verify the identity of at least one of the client's-customers.

6. The method according to claim 5, further comprising the step of providing verification of the individual's identity when the requested predetermined level of verification is achieved.

7. The method according to claim 6, wherein the verification of the individual's identity is provided to the client or to the client's customer.

8. The method according to claim 5, wherein the client is one of a financial institution, an Internet business, an Internet website or a regulated business.

9. The method according to claim 1, wherein each of the solutions has an associated measure of quality and wherein the step of choosing a solution includes choosing a solution based on its associated measure of quality.

10. The method according to claim 1, wherein each of the solutions has an associated cost and wherein the step of choosing a solution includes choosing a solution based on its associated cost.

11. The method according to claim 1, wherein each of the solutions has an associated time and wherein the step of choosing a solution includes choosing a solution based on its associated time.

12. The method according to claim 1, wherein if the requested predetermined level of verification is not achieved, a different solution is chosen from the composite set of solutions for the requested predetermined level of verification.

13. The method according to claim 1, wherein each solution in the composite set of solutions is based on at least one predetermined rule.

14. The method according to claim 13, wherein the predetermined rule is a function of at least one capability of a databroker.

15. The method according to claim 13, wherein the predetermined rule is a function of a geographic region.

16. The method according to claim 1, wherein at least one of the pieces of identifying information is a name, a national identification number, an address, a phone number, an e-mail address, a date of birth, a driver's license number, a passport number or financial information.

17. The method according to claim 1, wherein the predetermined level of verification is a level of verification established by a government statute or regulation.

18. The method according to claim 1, wherein the at least one databroker is a credit bureau, a government agency, a utility company, a financial institution or an information database.

19. A processor-based system for verifying the identity of an individual, the system being connected over a network to at least one databroker having the capability of verifying at least one piece of identifying information associated with an individual, the system comprising:
a memory, the memory being stored with:
at least one predetermined level of verification, each predetermined level of verification requiring the verification of at least one piece of identifying information by at least one databroker, wherein a predetermined level of verification is achieved when each piece of required identifying information is verified;
a composite set of solutions for achieving each predetermined level of verification, each of the solutions being associated with at least one databroker; and
processor-readable software code configured to enable the processor-based system to execute an identity verification process;
a processor, the processor being configured to execute the identity verification process, wherein the identity verification process includes the steps of:
receiving a request to verify the identity of an individual at a predetermined level of verification;
choosing a solution from the composite set of solutions for the requested predetermined level of verification; and
requesting, from the at least one databroker associated with the chosen solution, verification of at least one piece of identifying information associated with the requested predetermined level of verification.

20. The processor-based system according to claim 19, further comprising a user input device connected to said processor.

21. The processor-based system according to claim 20, wherein said user input device is configured to allow a user to establish one or more predetermined levels of verification.

22. The processor-based system according to claim 19, wherein the composite set of solutions are generated by said processor based on each predetermined level of verification.

23. The processor-based system according to claim 19, further comprising a server connected to the network, the server being configured to receive, from the at least one databroker associated with the chosen solution, a response to the request for verification of the at least one piece of identifying information.

24. The processor-based system according to claim 23, wherein said processor is configured to convert the response to a request for verification into a common data format.

25. The processor-based system according to claim 19, wherein said processor is connected over the network to a client and the request to verify the identity of an individual is a request from the client to verify the identity of at least one of the client's customers.

26. The processor-based system according to claim 25, wherein verification of the identity of the client's customer is provided to the client when the requested predetermined level of verification is achieved.

27. The processor-based system according to claim 25, wherein verification of the identity of the client's customer is provided to the customer when the requested predetermined level of verification is achieved.

28. The processor-based system according to claim 19, wherein the network is the Internet.

29. The processor-based system according to claim 19, wherein the network is a local area network.
